(19) United States
(12) Patent Application Publication
(10) Pub. No.: US 2015/0235242 A1
(43) Pub. Date: Aug. 20, 2015

(54) SYSTEM AND METHOD FOR INTERACTIVE FORECASTING, NEWS, AND DATA ON RISK PORTFOLIO WEBSITE

(71) Applicant: Altaira, LLC, Murray, UT (US)

(72) Inventors: Blaise F. Labriola, Park City, UT (US); Jared E. Stoddard, Salt Lake City, UT (US); Kevin G. Carter, South Jordan, UT (US); Zhongguo Yang, Chalfont, PA (US)

(73) Assignee: Altaira, LLC, Murray, UT (US)

(21) Appl. No.: 13/984,271

(22) PCT Filed: Aug. 2, 2013
(86) PCT No.: PCT/US2013/053502

§ 371 Date: Aug. 7, 2013

Related U.S. Application Data
(60) Provisional application No. 61/718,332, filed on Oct. 25, 2012.

(51) Int. Cl. G06Q 30/02

(52) U.S. Cl. CPC G06Q 30/0203

(57) ABSTRACT

A system receives public opinion information and then generates statistical output based upon the received information. Users access the system and enter their opinions or projections with respect to a particular subject. The system utilizes the entered information to provide users with public opinion and projection data. The amount of weight that any particular opinion is given depends upon the time that the opinion was submitted.

### CROSS-REFERENCE TO RELATED APPLICATIONS

This application is a U.S. National Stage Application of PCT Application No. PCT/US13/53502, filed on Aug. 2, 2013, entitled, “SYSTEM AND METHOD FOR INTERACTIVE FORECASTING, NEWS, AND DATA ON RISK PORTFOLIO WEBSITE,” which claims the benefit of priority to U.S. Provisional Patent Application No. 61/718,332 filed Oct. 25, 2012, entitled, “SYSTEMS AND METHODS FOR INTERACTIVE FORECASTING, NEWS AND DATA ON RISK PORTFOLIO WEBSITE,” and the entire content of which is incorporated by reference herein.

### BACKGROUND OF THE INVENTION

1. The Field of the Invention

This invention relates to generally to computer systems and methods used in the financial industry.

2. Background and Relevant Art

When researching subjects, such as stocks, world events, specific products, or other topics of interest, it can be difficult to gather unbiased information about the public's perception of the subject. For example, an individual may wish to access information about what the public projects the stock market will close at on a specific day, or an individual may wish to gather information about the public's perception of a particular product. While resources, such as articles or the analysis of various experts, opine about the public's perception of various subjects, many of these resources have biases or are otherwise constrained in what perceptions they are able to express. In many cases these biases and constraints are not known by the individuals who are accessing and relying upon the information.

Some conventional systems, in particular some systems available on the Internet, poll individuals about their perception of various subjects. Many of these conventional systems, however, require a user to answer a poll question with a binary answer, in many cases a positive or a negative perception. Therefore, these conventional systems may generate ambiguous data. For example, a first user may believe that the Dow Jones Industrial Average will close with a gain of 100 points for the day, while a second user may believe that the Dow Jones Industrial Average will close with a gain of 3 points for the day. Both the first user and the second user may be limited to expressing their projections merely as positive perceptions, which one will appreciate does not fully express the difference in projections between the two users.

Additionally, many conventional systems may fail to account for the timeliness of user's opinions. For example, a conventional system may prompt a user to enter an opinion regarding a particular topic. If the prompt remains on the Internet for a long period of time, various users may continue to enter their opinions regarding the topic. Conventional systems may fail to distinguish between recent public opinion regarding particular topics and old public opinion regarding the topic. As an additional example, a user may be prompted to predict a future event, such as a stock value. One will understand that a prediction of stock value that is only a short time period in the future will likely be more accurate than a predicted stock value that is a significant distance in the future. Accordingly, there are a number of deficiencies in the art that can be addressed.

### BRIEF SUMMARY OF THE INVENTION

Implementations of the present invention solve one or more of problems in the art with systems, methods, and apparatus for receiving public opinion and generating statistics based on the received opinion. In particular, in at least one implementation, the present invention can receive information relating to projected values for assets within a financial market. The projected values can influence a resulting aggregate prediction to varying degrees based upon how far in advance the projection was made.

For example, one implementation of the invention can include a method of displaying to a first user a computer interface comprising an opinion entry portion that prompts the user to enter an opinion regarding a specific topic. The method also includes receiving an indication of a user input within the opinion entry portion and associating with the user input a time stamp. The time stamp can correlate to the time that the indication of the user input was received. Additionally, the method can include using a computer processor to access information associated with at least one other input from at least one other user. The at least one other input from the at least one other user can be made in response to at least one prompt to enter an opinion regarding the same specific topic.

The method can further include using a computer processor to perform an aggregate opinion calculation based upon the user input and the information associated with the at least one other input from the at least one other user. The time stamp can be used to determine the influence that the user input has upon the aggregate opinion calculation. Further still, the method can include displaying, through a computer interface, a result of the aggregate opinion calculation to a second user, wherein the second user is distinct from the first user.

Additional features and advantages of exemplary implementations of the present invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. For better understanding, the like elements have been designated by like reference numbers throughout the various accompanying figures. Understanding that these drawings depict only typical embodiments of the invention and are not therefore to be considered to be limiting of its scope, the invention will be described and explained with additional specificity and detail through the use of the accompanying drawings in which:

FIG. 1 illustrates an architectural schematic diagram of a system for receiving public opinion and generating statistics based on the received opinion;

FIG. 2 illustrates an implementation of an opinion gathering interface of the present invention;

FIG. 3 illustrates an implementation of an opinion displaying interface of the present invention;

FIG. 4 illustrates an implementation of a stock value data interface of the present invention;

FIG. 5 illustrates an implementation of group projection data interface of the present invention;

FIG. 6 illustrates an implementation of a user projection data interface of the present interface;

FIG. 7 illustrates an implementation of a topic creation interface of the present interface; and

FIG. 8 illustrates a flow chart of a series of acts in a method in accordance with another implementation of the present invention for receiving public opinion and generating statistics based on the received opinion.

### DETAILED DESCRIPTION OF THE PREFERRED EMBODIMENTS

The present invention extends to systems, methods, and apparatus for receiving public opinion and generating statistics based on the received opinion. In particular, in at least one implementation, the present invention can receive information relating to projected values for assets within a financial market. The projected values can influence a resulting aggregate prediction to varying degrees based upon how far in advance the projection was made.

At least one implementation relates to receiving opinion information from the public about a variety of specific subjects. For example, the members of the public can provide their opinions through an online website. Users of the website can, among other options, enter current opinions about various subjects, enter projections about specific future events, or rank various different products. The users may enter their opinions by selecting a specific descriptor from a list of descriptors, by ranking various subjects against each other, by entering a text or numerical opinion, or by a variety of other methods.

In at least one implementation, the opinion information provided by the public can relate to subjects of financial or commercial interest. For example, individuals can project the price of a specific stock at various points in the future. In another example, individuals can share their opinions about a particular product, such as a new car model. Additionally, in at least one implementation, individuals can suggest specific subjects on which the public can express its opinion.

As the system gathers public opinion information, the system can display the public opinion information to the users. For instance, the system can display to users various statistics about the overall public opinion. The system may show the user, among other things, one or more of the following: the current predominant public opinion, the change over time in the public opinion, or in the case of quantifiable opinions—the highest, lowest, average, mode, and standard deviation of opinions.

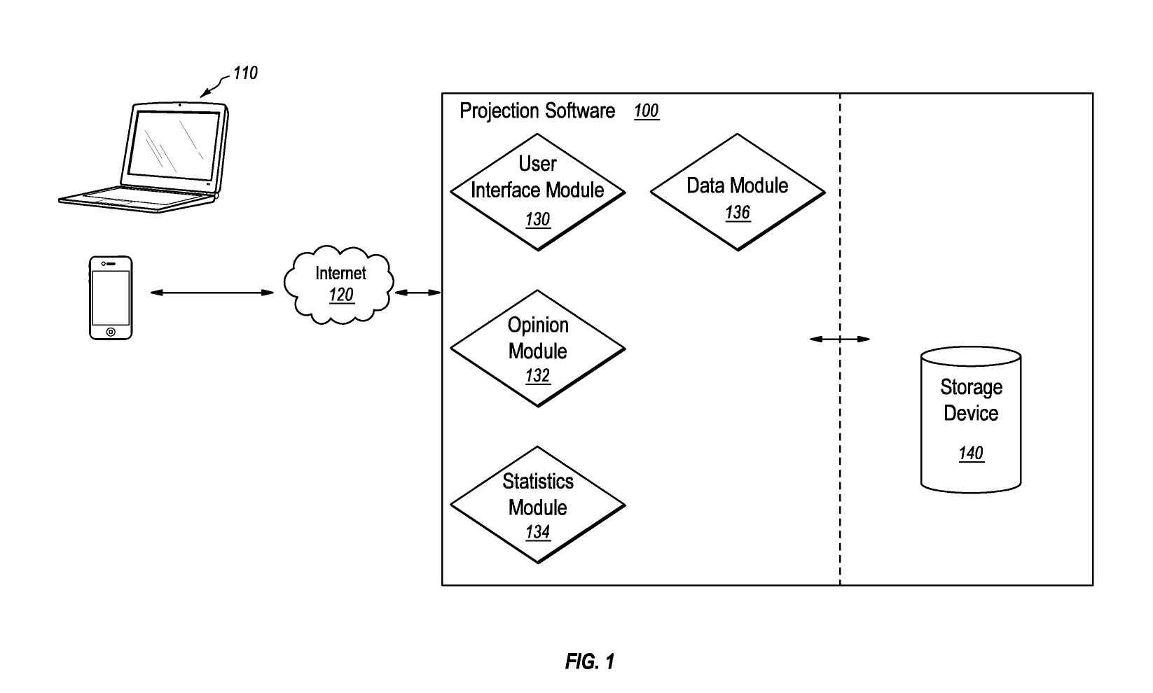

As stated above, in at least one implementation, the present invention can comprise a website. For example, FIG. 1 shows a diagram of the present invention implemented as projection software 100 that is accessible through the internet 120. One will understand that the projection software 100 can be implemented as a website that is accessible through the internet 120. The website can be accessed from a variety of web-enabled devices 110, such as mobile devices, laptop computers, or desktop computers. On some devices 110 the website can be accessed through a general purpose web browser, while on other devices it can be accessed through a dedicated application.

As shown in FIG. 1, at least one implementation of the projection software 100 comprises a user interface module 130, an opinion module 132, a statistics module 134, a data module 136, and a storage device 140. The opinion module 132 can direct the user interface module 130 to prompt a user to enter his or her opinion about various subjects. User's opinions can comprise a feeling about a subject, a projection about the future of a subject, a preferred state of a subject, information about the user that indicates an opinion, or any other form of data received from users

Once the projection software 100 has received a sufficient number of opinions from users, the statistics module 134 can calculate various statistics about the public's opinion on various subjects. For example, the statistics module 134 can determine the most common opinion, the average opinion, the highest opinion, the lowest opinion, and various other statistical related calculations. The user interface module 130 can then display the calculated statistics to a user of the projection software 100.

In addition to displaying the calculated statistics to users, in at least one implementation, the data module 136 can display actual data relating to particular topics. For example, the data module 136 can display current and historical values of particular stocks, currencies, mutual funds, etc. Accordingly, a user can enter a projected value for a particular stock at some point in the future. The data module 136 can direct the user interface module 130 to display the current value of the particular stock along with the historical value of the stock.

Additionally, over time, the opinion module 132 can display previous opinions that a user has entered. In at least one implementation, the data module 136 can then display the actual value of the previously opined-upon topic. For example, a user may have projected that stock XYZ would be worth $101 on a particular date in the future. Once that particular date has passed, the opinion module 132 can direct the user interface module 130 to display the user's projection of $101, while the data module 136 can direct the user interface module 130 to display the actual value of the stock on the projected day. In this way, the projection system 100 can display a user's projection and the actual value that resulted.

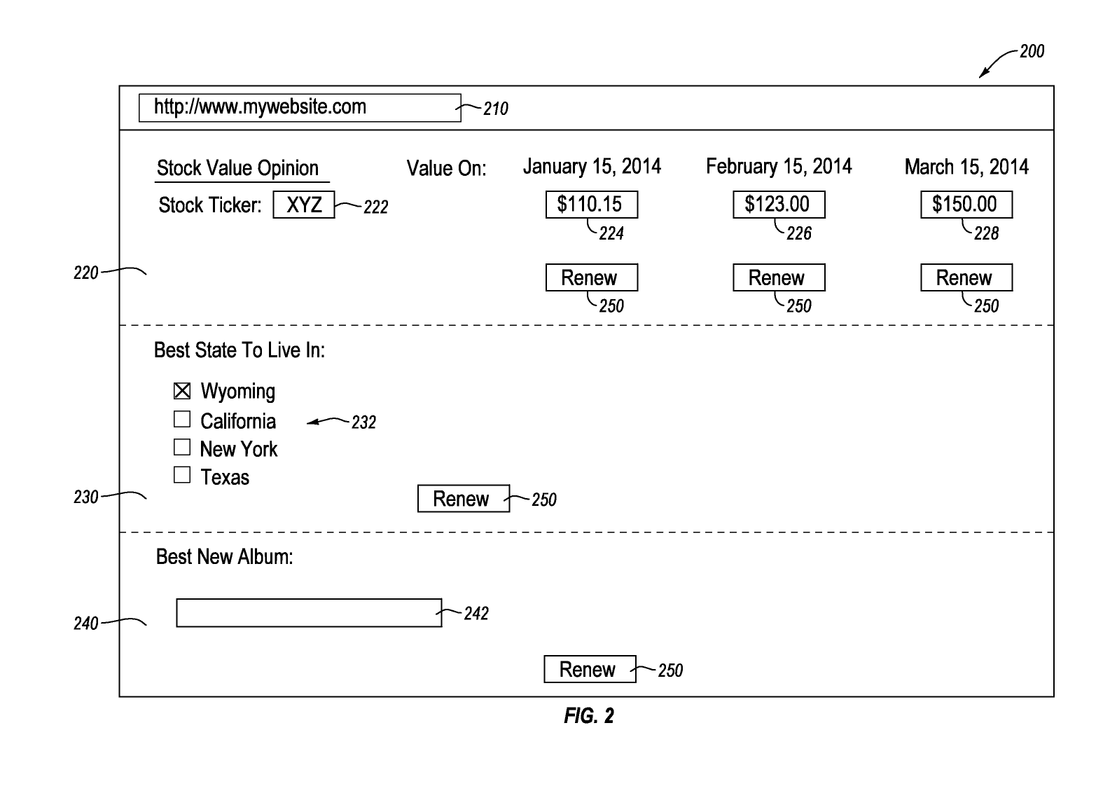

FIG. 2 shows an embodiment of an opinion gathering interface 200. As depicted, the opinion gathering interface 200 can accept a user's opinions relating to a variety of different topics and taking a variety of different forms. For example, a user's opinion can be numerical, meaning a user can express their opinion as a number on a numerical scale (e.g. 1-10) or the user can enter a number that reflects the user's opinion on a quantifiable subject. For example, a user can rank a particular product on a scale of one to ten (1-10), or a user can enter a number that reflects how much they would be willing to pay for the product.

As another example, and as depicted in FIG. 2, a user can enter a stock ticker 222 into the opinion gathering interface 200. The opinion gathering interface 200 can then provide a user with one or more boxes 224, 226, 228 to enter the user's prediction for the value of the stock on specific dates that correspond with each of the boxes 224, 226, 228. In FIG. 2, a user has entered a stock ticker of “XYZ,” and has predicted that the stock will be valued at $110.15 on Jan. 15, 2014, $123.00 on Feb. 15, 2014, and $150.00 on Mar. 15, 2014.

Additionally, in at least one implementation, the opinion gathering interface 200 can display an open-ended prompt to a user 240. The open-ended prompt 240 can request information from a user about a particular subject. For example, the open-ended prompt 240 can ask a user to identify the best new album. In response, the user can enter an album title. In this example, the open-ended prompt 240 is not asking a question with a finite number of responses, but is instead asking an open-ended question that can be answered a number of different ways.

In at least one implementation, the opinion gathering interface 200 can also include a ranking section 230 that prompts a user to provide his or her opinion by selecting a specific item from a group of items. For instance, the ranking section 230 may prompt a user to express his or her opinion about the best state with the United States, and the system may provide the user with the options of Wyoming, California, New York, or Texas. As shown in FIG. 2, the user can then select one of the provided options.

One will understand that the examples provided in FIG. 2 are only exemplary, and that various implementations can request any number of different opinions from a user. Further, one will understand that the methods of gathering user opinions can also vary widely and do not need to be limited to the three methods depicted in FIG. 2.

For example, in at least one implementation, the opinion gathering interface 200 can ask a user for non-opinion based information. For example, the opinion gathering interface 200 can inquire into how many cellphones a user owns. Based upon an aggregate of responses from various users, the statistics module 134 can generate a variety of different statistics relating to cellphone ownership. Some of the generated statistical information can also be used to infer opinion based data. For example, if the opinion gathering interface 200 also prompted user to enter in the number of landline phones they owned, and it was discovered that cellphones far outnumbered landline phones, the statistics module 134 could infer that the users preferred cellphones over landline phones.

Additionally, the opinion gathering interface 200 can also divide subjects within the system into different categories. For example, a financial category may contain subjects relating to stock values, while a political category may contain subjects relating to political policies and elections. Additionally, individuals can express their opinions on an entire category. For instance, the opinion gathering interface 200 can ask a user to rank the entire political category on a scale or one to ten. Similarly, the opinion gathering interface 200 can ask a user to express a binary opinion of like or dislike with respect to the category.

As described above and depicted, the opinion gathering interface 200 can also enable a user to make projections about specific subjects, with the projections being for specific times in the future. As depicted in FIG. 2, a user can project the value of XYZ stock one month in the future, two months in the futures, and three months in the future.

If the future times are static, then, as the specific times approach, the system can prompt the user to continually renew or change his or her opinion on what the value will be on those specific days. For example, once the first “one month in the future” date passes, the system can add a new date that is three months in the future. The previous “two months in the future” date can become the new “one months in the future” date, and the previous “three months in the future” date can become the new “two months in the future” date. For instance, once Jan. 15, 2014 arrives, the implementation of FIG. 2 can add a new projection prompt for Apr. 15, 2014, and remove the prompt for Jan. 15, 2014.

If the future times are dynamic then the system can prompt the user to continually express an opinion about the value of the particular stock at one month, two months, and three months from the time that the user is expressing his or her opinion. In this implementation, the specific dates that are requested on FIG. 2 would depend upon the day that the user logged into the opinion gathering interface 200. For example, if a user logged into the system on Jan. 17, 2014, then the opinion gathering interface 200 may prompt the user for a projection of stock value on Feb. 17, 2014, Mar. 17, 2014, and Apr. 17, 2014.

In at least one implementation, when a user's opinion is provided, the opinion module 130 can associate a time stamp with the opinion. Additionally, the statistics module 134 can associate a rate of decay with the opinions that are provided regarding at least one subject. As time passes the rate of decay causes the system to give less weight to older opinions in calculating statistical data based upon the cumulative shared opinions. The statistics module 134 can also associate different rates of decay for different subjects. In at least one implementation, the statistics module 134 allows a user to dynamically adjust the rate of decay associated with a particular subject to influence the statistical calculations that the user interface module 130 displays to the user.

Additionally, in at least one implementation, the statistics module 134 can perform a weighted average upon numerical data that has been entered. For instance, the statistics module 134 can perform the weighted average by multiplying each user opinion by a factor that is associated with rate of decay for the particular subject and the age of the opinion. In at least one implementation, the rate of decay for a particular user opinion is not constant but increases as time passes.

In the above described implementation regarding rates of decay, a user can renew 250 a projection or opinion. For example, a user can submit an opinion that he or she believes the Dow Jones Industrial Average will close at 12,000 on a specific date three months in the future. As time passes and the date comes closer, the statistics module 134 gives the original opinion less weight in statistical calculations compared to other more recent opinions from the public. The user, however, can later renew his or her opinion, by selecting a renew option 250, that the Dow Jones Industrial Average will close at 12,000 on the specific date. Once renewed, the statistics module 134 can give the renewed opinion full weight in calculating statistical data.

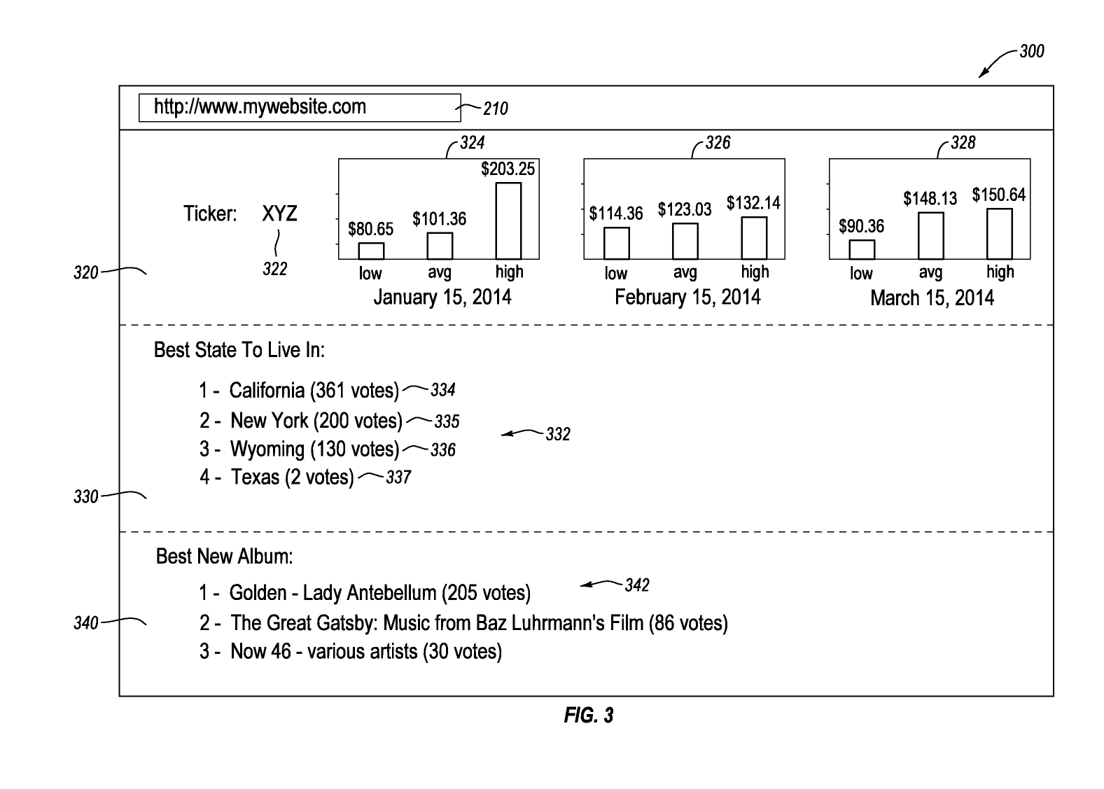

FIG. 3 depicts an implementation of a statistics display interface 300. As depicted, the statistics display interface 300 can include a stock information section 320, a ranking information section 330, and an open question information section 340. The stock information section 320 displays information relating to the various projected values of the XYZ stock 322. In particular, the stock information section 320 displays an average public projection, a low public projection, and a high public projection for three different future dates 324, 326, 328. In additional implementations, more or fewer future dates can be depicted along with different statistic indicators including, but not limited to, standard deviation, median, most recent opinion, most recent trend, etc.

FIG. 3 further depicts that the ranking information section 330 can include the results of a particular public ranking. For instance, FIG. 3 depicts the public ranking of “the best state to live in.” In particular, the ranking information section 330 provides a list of the states 332 ordered by highest number of votes. Additionally, the ranking information section 330 displays a number 334, 335, 336, 337 that indicates the number of votes that each respective state received. In at least one implementation, the ranking information section 330 can display information that is specific to a particular user. For example, the ranking information section 330 can display the stocks over time the user has ranked the highest.

One will understand that a wide variety of topics can be presented to users for ranking and, in turn, can be presented within the ranking information section 330. For instance, the system can display both the stocks that the user ranks the highest and the stocks that the public ranks highest. The system can also display, among other things, a lowest ranked subject, a most-actively-opined-on subject, a least-actively-opined-on subject, a subject that has demonstrated the fastest changing public opinion, or a subject that was most recently opined on.

FIG. 3 also depicts an open question information section 340. In this section 340, the statistics display interface 300 displays information relating to an open-ended question that was previously presented to the public. In this case, the open question information section 340 displays a ranking of the “Best New Album.” In contrast to the ranking displayed by the ranking information section 330, the open question information section 340 was not originally based upon a selectable, finite list of options. For example, FIG. 2 depicts a ranking section 230 that includes four selectable options consisting of “Wyoming,” “California,” “New York,” and “Texas.” The open ended opinion section 240 depicted in FIG. 2, however, comprises only an open text box that allows a user to enter the name of any album.

One will understand that there is a variety of different methods that can be used to display statistics regarding the public's opinion of a particular topic. For example with respect to quantifiable opinions, the statistics module 134 can calculate, among other things, a maximum value, a minimum value, a mean value, a mode value, a standard deviation, and a number of opinions that were given about the subject. Additionally, the data displayed by the statistics display interface 300 can be dynamically updated to reflect real-time changes in the public opinion with respect to the displayed subjects.

Additionally, in at least one implementation, when performing statistical calculations the statistics module 134 can identify outliers within the opinions that various users have entered. Specifically, an outlier can occur when the system receives a value that is substantially different than expected or is substantially different from the opinions that have been previously entered. Outliers can have a negative skewing effect on the statistics that are displayed by the system.

For example, the statistics can be incorrectly skewed if a user projects that on a specific day three-months in the future the Dow Jones Industrial Average will close at 999,999,999 points. If such a projection is received by the statistics module 134 and not accounted for, the projected closing price of the Dow Jones Industrial Average on the specific day three-months in the future will be heavily skewed. Additionally, if the system does not account for outliers, certain statistical information, such as the highest projected value, will be useless to individuals who access the data because, as in this exemplary case, the highest projected value is absurd.

In at least one implementation, the statistics module 134 can treat users' opinions as outliers if they are outside of a specific threshold from an expected input value. In particular, the statistics module 134 can determine an expected input value and/or the threshold mathematically, or from expert sources, historical data, or from public opinion data that has previously been entered. If public opinion data is used, whenever a new opinion is submitted that does not have sufficient correlation with previously submitted public opinion data then the statistics module 134 determines that the new opinion is an outlier.

In at least one implementation, the statistics module 134 can also increase or decrease the threshold based on how far into the future the user projected. For example, the statistics module 134 may provide a significantly larger threshold to projections that are a significant distance into the future. In contrast, the statistics module 134 can provide a much smaller threshold for projections that are only a short time in the future because. One will understand that generally it is much easier to accurately predict a value or value range that is only a short distance in the future than it is to predict one that is a significant distance in the future.

When a user's projection falls outside the threshold, the statistics module 134 can ignore that entry when calculating public opinion statistics. In at least one implementation, even though the statistics module 134 does not display the outlier to the public or account for the outlier in public calculations, the statistics module 134 can calculate the outlier into the personal statistics of the user and display the outlier to the user within the user's personal statistics.

Additionally, in at least one implementation the statistics module 134 can perform statistical calculations on discrete numbers, and can generate results that are also discrete numbers. For example, the user interface module 130 can display a request to receive the public's opinion about a particular subject on a scale of one to ten. If two users enter a ranking of “1” and one user enters a ranking of “2,” the average ranking will be “1.333.” In contrast to generating an answer that contains a decimal point, the statistics module 134 can generate an answer that is also a discrete number. For instance, the statistics module 134 may use a ceiling function, a floor function, some other appropriate mathematical function, or the system may round the number to the nearest integer.

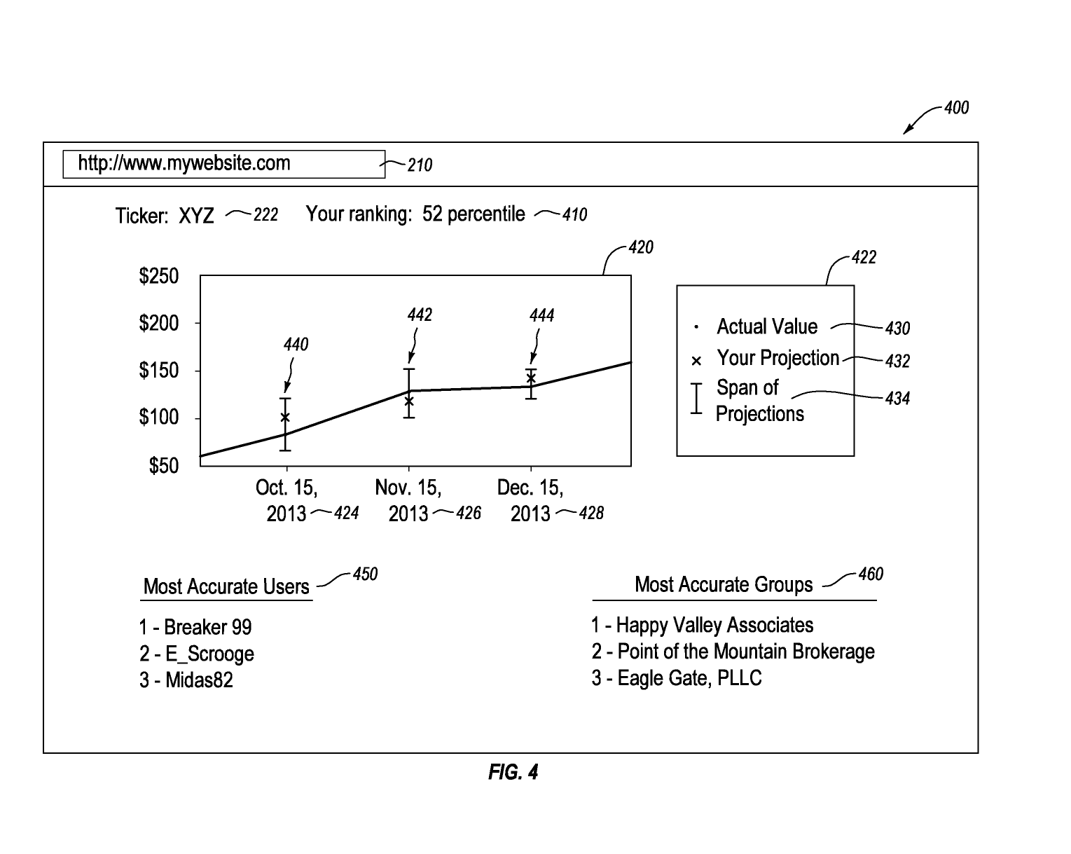

Additionally, as shown in FIG. 4, in at least one implementation, the user interface module 130 can display a topic-specific page 400. In particular, FIG. 4 shows that an exemplary topic specific page 400 can comprise a page directed towards the XYZ stock 222. In at least one implementation, this page can include information directed towards the public's projections and opinions relating to the topic, a user's projections relating to the topic, and various sections related to the accuracy various projections.

For example, FIG. 4 depicts a topic value and projection section 420. As depicted, this section 420 can display a historical depiction of actual stock values, along with a range of projections for each respective value 440, 442, 444. Along these lines, FIG. 4 shows that the topic specific page 400 can include a key 422, which defines various elements of the topic value and projection section 420. In this case, the key defines an “x” 432 as being associated with a specific user's projection, a dot 430 as being associated with the actual stock value, and a span 434 as being associated with the span of projections. Similarly, the topic value and projection section 420 can also display projection values for the future. One will understand that in light of the above discussion that the span 434 may or may not include outliers.

FIG. 4 also depicts a user ranking 410. In at least one implementation, the statistics module 134 and data module 136 can calculate a user ranking 410 that is based upon the individual user's projection accuracy, as compared to other users. In this case the user ranks in the 52 percentile for his or her accuracy in projecting the value of the XYZ stock 222. In addition to displaying a user ranking 410, the topic specific page 400 can also display a ranking of the most accurate users 450, and a ranking of the most accurate groups 460. In at least one implementation when calculating ranking, correct projections that were made further in advance are given more weight than correct projections that were made closer to the projection date.

In at least one implementation, any number of users can form a group within the projection software 100. For example, a stock brokerage may desire to form a group that includes the employees of the brokerage. One will understand that providing a ranking system may benefit both individuals and groups by providing marketing opportunities. In particular, users of the projection software 100 may be attracted to groups or users that rank highly in their projections.

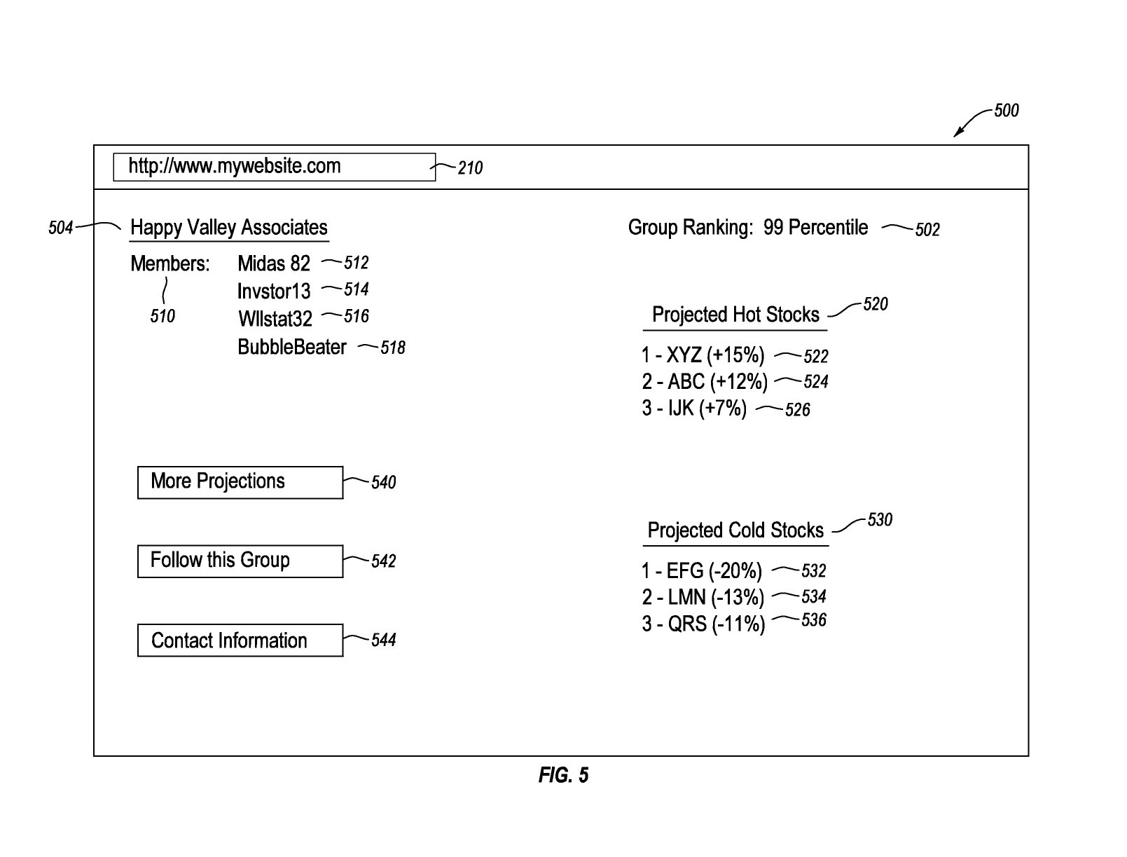

For example, FIG. 5 depicts a group projection page 500. The depicted page 500 is associated with a group known as Happy Valley Associates 504. The page 500 displays a listing 510 of members 512, 514, 516, 518 of the group 504, a group accuracy ranking 502, a group of stocks that the group projects will be hot 520, and a group of stocks that the group projects will drop in value 530. Additionally, the page 500 includes selectable options 540, 542, 544 to receive additional information relating to the group. In particular, a user can choose to view more projections that have been made by the group 540, and can view a selection to follow the group 542, or view a selection to contact the group 544.

One will understand that the described page 500 can serve as a marketing and recruitment tool for an organization. As noted above, for example, users can follow a group. In at least one implementation, following a group can provide a user with updates regarding recent projections that group makes, which a user can then use to shape the user's own stock decisions. However, in at least one implementation, a group can prevent the general public or even specific users from accessing the group's group projection page 500. This may be useful for a group that does not want to widely share its projections and/or market insight.

In at least one implementation, when calculating group statistics, such as shown in sections 520 and 530 of FIG. 5, the statistics module 134 can average the projections that are made by each member 512, 514, 516, 518 of a group 504 to arrive at a group projection. In contrast, in at least one implementation, a separate and distinct group projection can be made by some form of consensus among the members 512, 514, 516, 518 of a group 504.

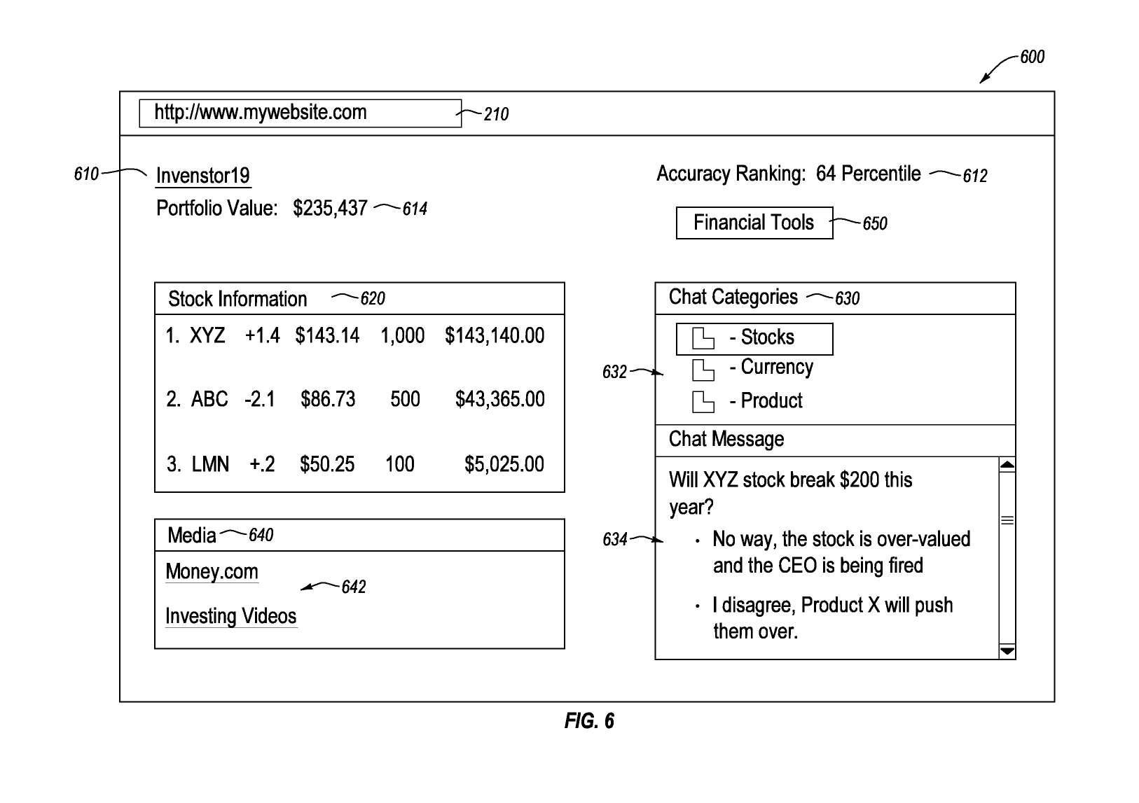

In contrast to the group projection page 500, FIG. 6 shows an implementation of an individual user projection page 600, which, as the name implies, is directed towards information relating to individual users. In order to access a user projection page 600, a user may be required to provide a password or some other form of login information. In at least one implementation, this login information may also be required in order to make projections within the projection software 100. Once a user has created a user profile the user can access an associated user projection page 600 and join various groups.

In at least one implementation, a user can create a group that includes only individuals that the user invites to join the group. As mentioned above, the user or other members of the group can access statistics that are based on only the opinion of members of the group. In contrast, the group's statistical information can also be accessible by the public. The projection software 100 can provide options that allow members of the group to control whether their group's statistical information is viewable by the public. Similarly, the projection software 100 can provide options that allow a user to control access to the user's own user projection page 600.

In addition to providing established groups within the projection software, in at least one implementation, a user can dynamically create groups in order to adjust the statistics and data that are displayed to the user. For example, if a user wants to see statistics and data relating to the opinions of a specific demographic, the projection software 100 enables the user to dynamically create a group that is limited to that demographic.

Additionally, in at least one implementation, the user interface module 130 allows a user to customize his or her user projection to only display information about the user's own opinions. For example, the system can allow the user to customize his or her private statistics portion to only display the user's own historic rankings of a particular mutual fund. Similarly, the system can allow the user to customize his or her private statistics portion to display the opinion information from a specific group. For instance, a user may desire to view the opinion of a group of associates about a particular subject.

Additionally, in at least one implementation, the user projection page 600 displays information relating to the accuracy of the user's own projections and opinions. For example, the page 600 can display a percentile rank 612 for the accuracy of the user. In at least one implementation, the page 600 can also display accuracy ratings for one or more of the users previous projections.

In addition to providing accuracy information, the page 600 can also display factual information of interest to the user. For example, the data module 136 can provide information relating to the actual stock values that the user is tracking. Additionally, the page 600 can also provide chat functions 634 that allow a user to chat with the public in general or with specific individuals. The user can also select a particular topic 630 of interest when deciding to chat. For example, FIG. 6 shows potential topics 632 of stocks, currency, and product. FIG. 6 also shows a chat function 634 taking place, where a user can type questions and receive answers from other users.

In at least one implementation, the projection software 100 also allows the user to create a favorites list that includes the subjects that the user is most interested in. For example, a user may be interested in hockey teams and trucks, and the user may own stock in a first company and a second company and be interested in public opinion about the future price of those stocks. The user can add the categories of hockey teams and trucks and the subjects of the first company's stock price and the second company's stock price to the user's favorites list. When the user logs into his or her user projection page 600, the page can display the current statistical calculations and data relating to the public's opinion about each item within the user's favorites list.

In addition to, or as part of, the user projection page 600, a user can also receive access to a financial analysis application 650. In at least one implementation, the financial analysis application can use statistical data from the system about the public's opinion of various financial subjects when performing its calculations. The financial analysis application can also compare calculations that the application performed to projections that the user made or projections that the public made. A user can utilize the financial analysis application to monitor various risk factors that could impact the user's investment portfolio.

Additionally, the user projection page 600 can contain a media section 640 that provides to users information relating to a wide variety of topics 642. As shown in FIG. 6, for example, media section 640 displays a variety of linkable news headlines 642. A user can customize the news topics that are displayed by the user projection page 600. For example, a user can customize the page 600 to display technology news, financial news, and political news.

The media section 640 can also provide to the user multimedia directed towards topics of interest. For example, FIG. 6 shows that media section 640 can comprise videos segments from newscasts or audio recordings of expert analysis. A user can gain insight about a specific subject from the media section 640 and then provide his or her opinion or projection regarding the specific topic.

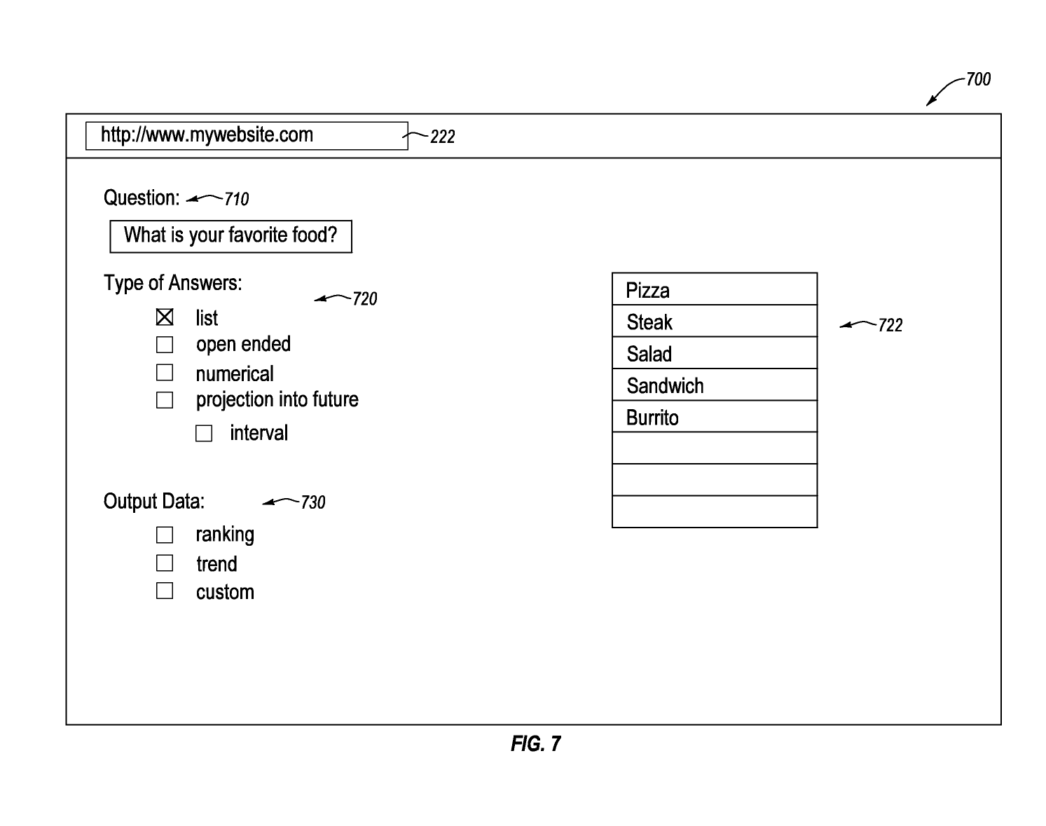

FIG. 7 depicts an implementation of a poll creation interface 700. The poll creation interface 700 allows a user to suggest or create subjects or categories for the public to express its opinion on. For example, a user may wish to know the public's opinion about a particular sports car. The poll creation interface 700 enables a user to create a component on the webpage that invites individuals to share their opinions on specific aspects of the sports car. In at least one implementation, an administrator of the webpage must approve a suggested poll before it is presented to the public. This can allow the administrator to filter the submitted subjects to verify that they are appropriate.

When creating a subject or category for public opinion a user can enter a question or prompt into a question section 710. For example, FIG. 7 shows that the user has submitted the question, “What is your favorite food?” The poll creation interface 700 can also provide the user with a selection of answer types 720. For example, a user may be interested in receiving a ranking of a set of possible answers, an open answered response, a numerical assignment (e.g., a number of hamburgers a person eats each month), a projection of future value (i.e., projected stock values), which can be customized to a particular interval, or some other form of response.

FIG. 7 depicts a situation in which the user has selected a “list” as the desired type of answer. Accordingly, the poll creation interface 700 provides a list item entry portion 722. In this case, the user has entered “pizza,” “steak,” “salad,” “sandwich,” and “burrito” as possible answers. In at least one implementation, in addition to providing an answer type, a user can also specify a particular type of output data 730. For example, in the case of a list, a user can direct the poll creation interface 700 to output a ranking of the answers, a trending answer, or create a custom output format.

In other implementations, a poll question 710 that accepts numerical input may have predefined statistical outputs for an average, a median, a mode, a standard deviation, a highest input, a lowest input, or any number of other desirable numerical based outputs. Similarly, a poll question 710 that accepts text input may have predefined functions that account for variations in the spelling of words, account for different words with similar meanings, determine the most and least often entered answer, or perform other desirable operations on text input.

Additionally, the output data section 730 can provide a user with the tools to create personalized algorithms and functions that operate on the subject for which the user wants public opinion. For instance, a user can create a personalized algorithm that determines a specific distribution of the public opinion about a subject by entering the appropriate mathematical function. The system can display the output of the users personalized algorithms to the user or to the public.

In other examples, the user may be interested in what color of a particular sports car the public likes most. The poll creation interface 700 can provide a user with tools to create a question about which color of the particular sports car is best. The poll creation interface 700 can then enable the user to provide as possible answers: Red, Blue, Green, Yellow, or any other color of interest. In another case, the user may be interested to find how highly the public ranks the particular sports car on a scale of one to ten. The poll creation interface 700 can provide a user with tools to create a component on the website that asks the public to rank the particular sports from one to ten.

In at least one implementation, the projection software 100 also can provide an administrator or user with tools to set a time period over which a subject or category is available for public opinion. For example, the poll creation interface 700 may allow a user to create an item that asks the public to project who will win an election. The poll creation interface 700 enables the user to set the item to expire on the date the election is decided. Additionally, the projection software 100 can delete a category or subject if it remains inactive for a specific amount of time. For instance, if a month passes since the last time that a user expressed an opinion on a particular subject then the system can automatically delete the subject.

Accordingly, FIGS. 1-7 and the corresponding text illustrate or otherwise describe one or more components, modules, and/or mechanisms for receiving public opinion and generating statistics based on the received opinion. One will appreciate that implementations of the present invention can generate large amounts of public data and public projections relating to a variety of subjects. In particular, the described system can project stock values at intervals into the future.

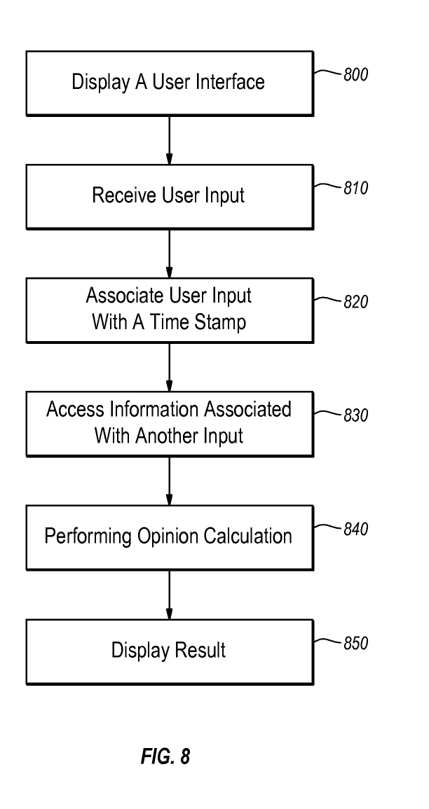

In addition to the foregoing, one will appreciate that implementations of the present invention can also be described in terms of flowcharts comprising a sequence of one or more acts in a method for accomplishing a particular result. For example, FIG. 8 illustrates a method for receiving public opinion and generating statistics based on the received opinion. The acts of FIG. 8 are described below with respect to the components, modules and diagrams of FIGS. 1-7.

For example, FIG. 8 illustrates that a method for receiving public opinion and generating statistics based on the received opinion can comprise an act 800 of displaying a user interface. Act 800 includes displaying to a first user a computer interface, the computer interface comprising an opinion entry portion that prompts the user to enter an opinion regarding a specific topic. For example, FIG. 2 shows an interface prompting a user to enter opinions regarding stock values, the best state to live in, and the best new album.

FIG. 8 also shows that the method can include an act 810 of receiving user input. Act 810 includes receiving an indication of a user input within the opinion entry portion. For example, FIG. 2 shows, among other opinions, a user entered opinion that the best state to live in is Wyoming.

Additionally, FIG. 8 shows that the method can include an act 820 of associating a user input with a time stamp. Act 820 includes associating with the user input a time stamp, wherein the time stamp correlates to the time that the indication of the user input was received. For example, the description relating to FIG. 2 describes associating a time stamp with a user input.

FIG. 8 further shows that the method can include an act 830 of accessing information associated with another input. Act 830 includes accessing, using a computer processor, information associated with at least one other input from at least one other user, wherein the at least one other input from the at least one other user was in response to at least one prompt to enter an opinion regarding the specific topic. For example, FIG. 3 depicts the results of entered opinions from a plurality of different users; and, in particular, that 316 users submitted an opinion that California was the best state in which to live.

FIG. 8 also shows that the method can include an act 840 of performing an opinion calculation. Act 840 includes performing, using a computer processor, an aggregate opinion calculation based upon the user input and the information associated with the at least one other input from the at least one other user, wherein the time stamp is used to determine the influence that the user input has upon the aggregate opinion calculation. For example, FIG. 3 depicts the cumulative results of entered opinions from a plurality of different users

Further, FIG. 8 shows that the method can include an act 850 of displaying a result. Act 850 includes the computer processor directing one or more rendering components to display displaying, through a computer interface, a result of the aggregate opinion calculation to a second user, wherein the second user is distinct from the first user. For example, FIG. 3 depicts the cumulative results of entered opinions from a plurality of different users.

Accordingly, one will appreciate in view of the specification and claims herein that one or more implementations of the present invention allow a user to submit his or her opinion regarding a wide variety of topics, and to access an aggregate public opinion regarding a topic, such as a future stock value. The user can then use this information in marketing or personal financial decisions, as desired. One will appreciate that implementations of the present invention can help ensure the accuracy of results used by users relevant to tracking and displaying various forecasts and preferences of interest to individual users, or to the public generally.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, DVD, or other optical disk storage, magnetic disk storage or other magnetic storage devices, or any other medium which can be used to store desired program code means (software) in the form of computer-executable instructions or data structures and which can be accessed by a general purpose or special purpose computer.

A “network” is defined as one or more data links that enable the transport of electronic data between computers and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer RAM and/or to less volatile computer storage media (devices) at a computer. Thus, it should be understood that computer storage media (devices) can be included in computer components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computers, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A method for receiving public opinion and generating statistics based on the received opinion, the system comprising:
displaying a user interface, the user interface comprising an opinion entry portion that prompts a user to enter an opinion regarding a specific topic;
receiving an indication of a user input within the opinion entry portion;
associating with the user input a time stamp, wherein the time stamp correlates to the time that the indication of the user input was received;
accessing, using a computer processor, information associated with at least one other input from at least one other user, wherein the at least one other input from the at least one other user was in response to at least one prompt to enter an opinion regarding the specific topic;
calculating, using a computer processor, an aggregate opinion based upon the user input and the information associated with the at least one other input from the at least one other user, wherein the time stamp is used to determine the influence that the user input has upon the aggregate opinion calculation; and
the processor causing rendering instructions to display through a computer interface, a result of the aggregate opinion calculation to a second user, wherein the second user is distinct from the first user.

2. The method as recited in claim 1, further comprising:
associating a drop date with the user input, wherein the drop date is an indication of a particular time span extending from the time of the time stamp.

3. The method as recited in claim 2, further comprising:
accessing an indication of the current time and date;
determining, based upon the current time and date, that the drop date has lapsed;
performing the aggregate opinion calculation based upon the information associated with at least one other input from at least one other user and without using the user input; and
displaying a result of the aggregate opinion calculation to a second user, wherein the second user is distinct from the first user.

4. The method as recited in claim 1, wherein performing the aggregate opinion calculation comprises:
determining a weighted user input by applying a weighting function using at least the time stamp that is associated with the user opinion, wherein the weighting function is specific to the specific topic; and
performing, using a computer processor, the aggregate opinion calculation based upon at least the weighted user input and the information associated with the at least one other input from the at least one other user.

5. The method as recited in claim 4, wherein the weighting function operates as a time decay function such that the weighted user input diminishes over time.

6. The method as recited in claim 4, further comprising:
determining a drop date that is associated with the specific topic, wherein the weighting function gradually diminishes the weighted user input until the weight user input is zero when the drop date is reached.

7. The method as recited in claim 4, further comprising:
displaying to the first user a computer interface, the computer interface comprising the opinion entry portion, the opinion entry portion requesting that the first user enter a projected value for the specific topic on a specific projection time in the future; and
performing, using a computer processor, the aggregate opinion calculation based upon the user input and the information associated with the at least one other input from the at least one other user, wherein a time span between the time stamp and the specific projection time is used to determine the influence that the user input has upon the aggregate opinion calculation.

8. The method as recited in claim 7, further comprising:
determining the weighted user input by applying the weighting function using at least the time stamp and the specific projection time, wherein the greater the time span between the time stamp and the specific projection time the smaller the resulting weighted user input.

9. The method as recited in claim 1, wherein the user is prompted to enter an opinion relating to financial valuation.

10. The method as recited in claim 9, wherein the user is prompted to enter a projected financial value for a particular entity at a specific time in the future.

11. A server computer-based system comprising one or more processors configured to execute computer-executable instructions stored on one or more computer-readable storage devices, the instructions when executed by the one or more processors, causing the computed-based system to perform a method for receiving public opinion and generating statistics based on the received opinion, the method comprising:
receiving from one or more client computer systems over a network one or more messages comprising a first user opinion from a first user;
associating with the first user opinion a first time stamp, wherein the first time stamp corresponds with the time that the first user opinion is received by the computer-based system;
receiving from one or more other client computer systems over the network a second user opinion from a second user;
associating with the second user opinion a second time stamp, wherein the second time stamp corresponds with the time that the second user opinion is received by the computer-based system;
performing, using a computer processor, an aggregate opinion calculation based at least upon the first user opinion, the second user opinion, the first time stamp, the second time stamp, and a decay formula; and
sending display instructions to the first and client computer systems that comprises the aggregate opinion calculation.

12. The system as recited in claim 11, further comprising:
associating a drop date with the first user opinion, wherein the drop date is an indication of a particular time span extending from the time of the time stamp.

13. The system as recited in claim 12, further comprising:
accessing an indication of the current time and date;
determining, based upon the current time and date, that the drop date has lapsed;
performing the aggregate opinion calculation based upon the information associated with at least one other input from at least one other user and without using the first user opinion; and
displaying a result of the aggregate opinion calculation to a second user, wherein the second user is distinct from the first user.

14. The system as recited in claim 11, wherein performing the aggregate opinion calculation comprises:
determining a weighted first user opinion by applying the decay formula to the first user opinion, wherein the decay formula determines a weighting factor to be applied to the first user opinion based at least upon the first time stamp; and
performing, using a computer processor, an aggregate opinion calculation based upon at least the weighted first user opinion and the information associated with the at least one other input from the at least one other user.

15. The system as recited in claim 14, wherein the weighting function operates as a time decay function such that the weight user input diminishes over time.

16. The system as recited in claim 14, wherein performing the aggregate opinion calculation comprises:
determining a weighted second user opinion by applying the decay formula to the second user opinion, wherein the decay formula determines a weighting factor to be applied to the second user opinion based at least upon the second time stamp; and
performing, using a computer processor, an aggregate opinion calculation based upon at least the weighted first user opinion and the weighted second opinion.

17. The system as recited in claim 14, wherein performing the aggregate opinion calculation comprises:
determining a weighted second user opinion by applying a different decay formula to the second user opinion, wherein the different decay formula determines a weighting factor to be applied to the second user opinion based at least upon the second time stamp; and
performing, using a computer processor, an aggregate opinion calculation based upon at least the weighted first user opinion and the weighted second opinion.

18. The system as recited in claim 11, wherein a user specifies the decay formula.

19. The method as recited in claim 11, wherein a user is prompted to enter an opinion relating to financial valuation.

20. A computer program storage device having computer-executable instructions stored thereon that, when executed by one or more processes, cause a computer system to implement a method for receiving public opinion and generating statistics based on the received opinion comprising:
displaying a user interface, the computer interface comprising an opinion entry portion that prompts the user to enter an opinion regarding a specific topic;
receiving an indication of a user input within the opinion entry portion;
associating with the user input a time stamp, wherein the time stamp correlates to the time that the indication of the user input was received;
accessing, using a computer processor, information associated with at least one other input from at least one other user, wherein the at least one other input from the at least one other user was in response to at least one prompt to enter an opinion regarding the specific topic;
performing, using a computer processor, an aggregate opinion calculation based upon the user input and the information associated with the at least one other input from the at least one other user, wherein the time stamp is used to determine the influence that the user input has upon the aggregate opinion calculation; and
displaying, through a computer interface, a result of the aggregate opinion calculation to a second user, wherein the second user is distinct from the first user.
